(19) United States
(12) Patent Application Publication
(10) Pub. No.: US 2013/0265197 A1
(43) Pub. Date: Oct. 10, 2013

(54) OMNI-DIRECTIONAL MULTIPLE-INPUT MULTIPLE-OUTPUT ANTENNA SYSTEM

(71) Applicant: Argus Technologies (Australia) Pty Ltd, Bella Vista (AU)

(72) Inventor: Bevan Beresford Jones, New South Wales (AU)

(21) Appl. No.: 13/630,820

(22) Filed: Sep. 28, 2012

(30) Foreign Application Priority Data
Mar. 31, 2010 (AU) 2010901354
Mar. 30, 2011 (AU) PCT/AU2011/000365

(51) Int. Cl. H01Q 3/40

(52) U.S. Cl. CPC H01Q 3/40
USPC 342/373

(57) ABSTRACT

Disclosed is an antenna system having an approximately omni-directional radiation pattern. The antenna system comprises an antenna comprising a plurality of columns disposed in parallel with equal spacing in a circular configuration. Each column comprises an elongated ground plane; an outwards-facing array comprising a plurality of antenna elements mounted on the ground plane iri a linear configuration parallel to the longitudinal edges of the ground plane, each antenna element comprises two feeds configured to produce orthogonally polarised radiation; a first input connected to the feeds configured for a first polarisation; and a second input connected to the feeds configured for a second, polarisation. The antenna system further comprises a feeding network comprising a first circuit network and a second circuit network. The first inputs of the columns are connected to respective outputs of the first circuit network, and the second inputs of the columns are connected to respective outputs of the second circuit network. Each circuit network is adapted to impart a phase shift to each of two inputs to the circuit network that increments between the outputs of the circuit network by a multiple of 360° divided by the number of columns.

### TECHNICAL FIELD

The present invention relates generally to antennas for cellular base stations and mobile devices and, in particular, to multiple-input multiple-output (MIMO) antennas.

### BACKGROUND

To provide omni-directional (360°) coverage at a base station in a cellular communication network, one approach is to use a single vertically polarised antenna. If dual polarised operation is required, a number, typically three, of dual polarised column antennas can be disposed equally around a notional circle. The ground planes of these column antennas form an equilateral triangle. Each column antenna covers approximately 120° of azimuth so that if one polarisation of each of the three column antennas is fed in phase with equal amplitude signals, approximately omni-directional coverage is obtained. The same applies to the other polarisation. The two polarisations are normally linear polarisations inclined at ±45° to vertical. The input signals to such an arrangement can be independent or identical, depending on the application. The two polarisations often have independent fading and can be used in a two-way multiple-input multiple-output (MIMO) configuration.

Present-day Long Term Evolution (i.e. 4th generation and subsequent) and WiMAX (IEEE 802.16) cellular base stations often have provision for use of four-way MIMO antennas. Commonly two spaced, dual polarisation antennas are used in this configuration. Such antennas are suitable for multipath environments as such antennas provide largely independent fading. However, this arrangement is not suitable if omni-directional coverage is required.

### SUMMARY

According to a first aspect of the present disclosure, there is provided an antenna system having an approximately omni-directional radiation pattern. The antenna system comprises an antenna comprising a plurality of columns disposed in parallel with equal spacing in a circular configuration. Each column comprises an elongated ground plane; an outwards-facing array comprising a plurality of antenna elements mounted on the ground plane in a linear configuration parallel to the longitudinal edges of the ground plane, each antenna element comprising two feeds configured to produce orthogonally polarised radiation; a first input connected to the feeds configured for a first polarisation; and a second input connected to the feeds configured for a second polarisation. The antenna system further comprises a feeding network comprising a first circuit network, and a second circuit network. The first inputs of the columns are connected to respective outputs of the first circuit network, and the second inputs of the columns are connected to respective outputs of the second circuit network. Each circuit network is adapted to impart a phase shift to each of two inputs to the circuit network that increments between the outputs of the circuit network by a multiple of 360° divided by the number of columns.

According to a second aspect of the present disclosure, there is provided a base station for a mobile network comprising the antenna system in accordance with the first aspect.

According to a third aspect of the present disclosure, there is provided a mobile device adapted for wireless communication with a base station in accordance with the second aspect.

### DESCRIPTION OF THE DRAWINGS

At least one embodiment of the present invention are described hereinafter with reference to the drawings, in which:

FIGS. 1a and 1b are plan and perspective views respectively of an omni-directional microwave antenna forming part of an antenna system according to one embodiment;

FIG. 2 is a front elevation view of one column of the antenna of FIGS. 1a and 1b;

FIG. 3 is a schematic diagram of a feeding network for the antenna of FIGS. 1a and 1b; and

FIG. 4 is a plot of the pattern amplitude of the antenna system according to the embodiment.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

Disclosed hereinafter are arrangements for a four-way omni-directional MIMO cellular antenna system for use at a base station in a mobile network. The disclosed arrangements provide a pattern of approximately equal amplitude in all directions, while mitigating the effects of fading in multipath environments. The disclosed arrangements make use of both polarisation and pattern diversity.

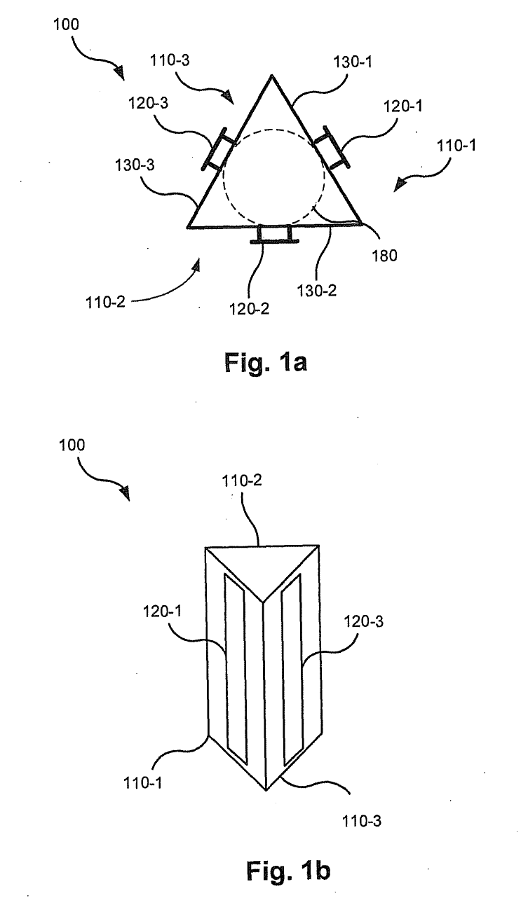

FIGS. 1a and 1b are plan and perspective views respectively of an omni-directional microwave antenna 100 forming part of an antenna system according to one embodiment. The antenna 100 comprises three identical “columns” 110-1, 110-2, and 110-3, disposed in parallel with equal spacing in a circular configuration around a notional circle 180. In FIGS. 1a and 1b, the columns 110-1, 110-2, and 110-3 about each other so that the columns 110-1, 110-2, and 110-3 form an equilateral triangle in the transverse direction. In other embodiments the columns 110-1, 110-2, and 110-3 are spaced apart, but still with equal spacing in a circular configuration.

Each column 110-i, where i=1, 2, 3, in FIGS. 1a and 1b comprises an elongated conducting ground plane 130-i and an outwards-facing antenna array 120-i mounted on the ground plane 130-i. The three ground planes 130-i are oriented at 60° angles relative to each other in the transverse direction. Each column 110-i produces a radiation pattern with broad azimuthal coverage, typically 80 degrees at the 3 dB points, centred on the normal to the corresponding ground plane 130-i. The columns 110-i are disposed around the notional circle 180 such that the distance between adjacent antenna arrays 120-i is approximately half a wavelength of the signals provided to the antenna 100.

FIG. 1b only shows a portion of the antenna 100 since in the perspective view the column 110-2 is obscured by the columns 110-1 and 110-3.

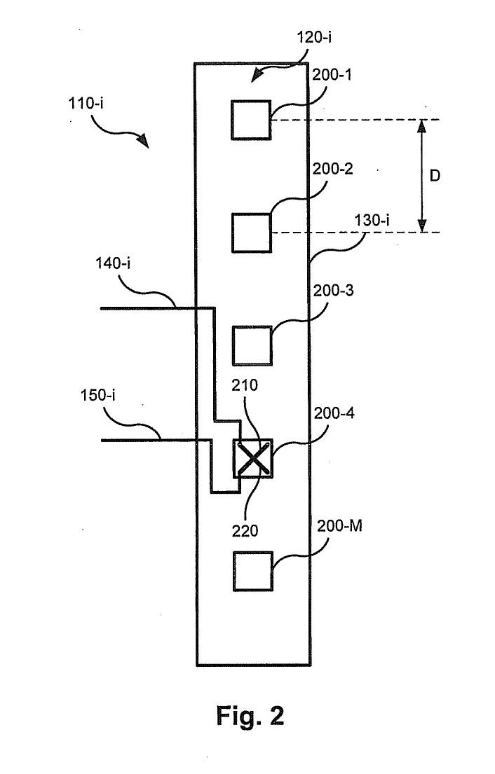

FIG. 2 is a front elevation view of one column 110-i of the antenna 100 of FIGS. 1a and 1b. The antenna array 120-i comprises M antenna elements 200-1, 200-2, . . . , 200-M mounted on the ground plane 130-i with equal spacing (labeled as D in FIG. 2) in a linear configuration parallel to the longitudinal edges of the ground plane 130-i. The elements 200 may be printed circuit board components, for example. Each antenna element 200-m (m=1, . . . M) has two feeds e.g. 210 and 220, configured to produce orthogonally polarised radiation. In FIG. 2, the feeds 210 and 220 produce linearly polarised radiation oriented at −45° and +45° to the longitudinal direction respectively. In other embodiments the feeds 210 and 220 produce circularly polarised radiation in opposite directions. The dimensions of each column 110-i scale in proportion to the wavelength of the signals provided to the antenna 100.

The array 120-i has a first input 140-i and a second input 150-i corresponding to the +45° and −45° polarisation directions respectively. The inputs of each +45° polarisation feed, e.g. 220, may be fed through a power divider (not shown) if a fixed beam is required or through respective phase shifters (not shown) if a beam with adjustable tilt is required. The power divider or the phase shifters are connected to the first input 140-i to the column 110-i. The inputs of each −45° polarisation feed, e.g. 210, are connected in the same way to the second input 150-i to the column 110-i.

The antenna 100 therefore has six inputs, three of which (140-1, 140-2, and 140-3) produce +45° polarised radiation and three of which (150-1, 150-2, and 150-3) produce −45° polarised radiation.

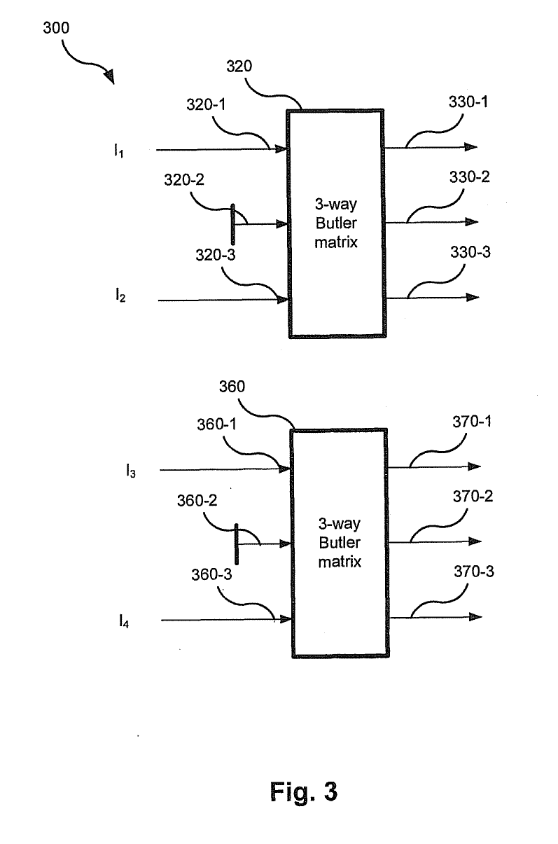

FIG. 3 is a schematic diagram of a feeding network 300 for the antenna 100 of FIGS. 1a and 1b. The antenna 100 and the feeding network 300 together make up the antenna system. The feeding network 300 is provided with four input signals I₁, I₂, I₃, and I₄ in conventional MIMO fashion. The four input signals I₁, I₂, I₃, and I₄ are the multiple inputs to the MIMO antenna 100 and may, for example, carry differently encoded versions of information to be transmitted. The two signals I₁ and I₂ are connected to the first and third inputs 320-1 and 320-3 of a first three-way Butler matrix 320. The second input 320-2 to the Butler matrix 320 is terminated. The three outputs 330-1, 330-2, 330-3 of the Butler matrix 320 are connected to the three +45° polarisation inputs 140-1, 140-2, and 140-3 respectively of the antenna 100.

The other two signals I₃ and I₄ are connected to the first and third inputs 360-1 and 360-3 of a second three-way Butler matrix 360. The second input 360-2 of the second Butler matrix 360 is terminated. The three outputs 370-1, 370-2, 370-3 of the second Butler matrix 360 are connected to the three −45° polarisation inputs 150-1, 150-2, and 150-3 respectively of the antenna 100.

The three-way Butler matrix 320 has the characteristic that a signal introduced at any of the inputs 320-1, 320-2, and 320-3 is split with equal amplitude to the outputs 330-1, 330-2 and 330-3.

If signal is introduced at 320-2, the outputs 330-1, 330-2, 330-3 are all in phase.

If signal (I₁) is introduced at 320-1, the outputs 330-1, 330-2, 330-3 have the phase relationship 0°, 120°, −120° respectively with respect to the signal I₁.

If signal (I₂) is introduced at 320-3, the outputs 330-1, 330-2, 330-3 have the phase relationship 0°; −120°, 120° respectively with respect to the signal I₂.

The Butler matrix 360 is identical to the Butler matrix 320 in that the Butler matrix 360 imparts a phase shift to its first input signal I₃ that increments by 120° between the three outputs 370-1, 370-2, and 370-3, and a phase shift to its second input signal I₄ that increments by −120° between the three outputs 370-1, 370-2, and 370-3, while preserving approximately equal amplitudes. That is, the first output 370-1 comprises the sum of two input signals I₃ and I₄ with zero phase shift. The second output 370-2 comprises the sum of the two input signals I₃ and I₄ with 120° and −120° phase shifts respectively and amplitudes approximately equal to the amplitudes of I₃ and I₄ in the first output 370-1. The third output 370-3 comprises the two input signals I₃ and I₄ with 240° (or) −120° and −240° (or) 120° phase shifts respectively and amplitudes approximately equal to the amplitudes of I₃ and I₄ in the first output 370-1.

In other embodiments, other three-way circuit networks such as Blass matrices imparting the same phase shifts are used in place of the Butler matrices.

Table 1 summarizes the effect of the feeding network 300 illustrated in FIG. 3.

TABLE 1

| | Column 110-1 | | Column 110-2 | | Column 110-3 | |
|---|---|---|---|---|---|---|
| Input | +45° | −45° | +45° | −45° | +45° | −45° |
| I₁ | 0° | — | 120° | — | 240° | — |
| I₂ | 0° | — | 240° | — | 120° | — |
| I₃ | — | 0° | — | 120° | — | 240° |
| I₄ | — | 0° | — | 240° | — | 120° |

The rows of Table 1 correspond to the signals I₁, I₂, I₃ and I₄ while the columns of Table 1 correspond to the six outputs (330-1, 370-1, 330-2, 370-2, 330-3, and 370-3) of the feeding network 300, which are the six inputs (140-1, 150-1, 140-2, 150-2, 140-3, and 150-3) to the antenna 100. Table 1 shows that, for example, the −45° input (150-2) to column 120-2 is the sum of the signal I₃ and the signal I₄ with phase shifts of 120° and 240° respectively.

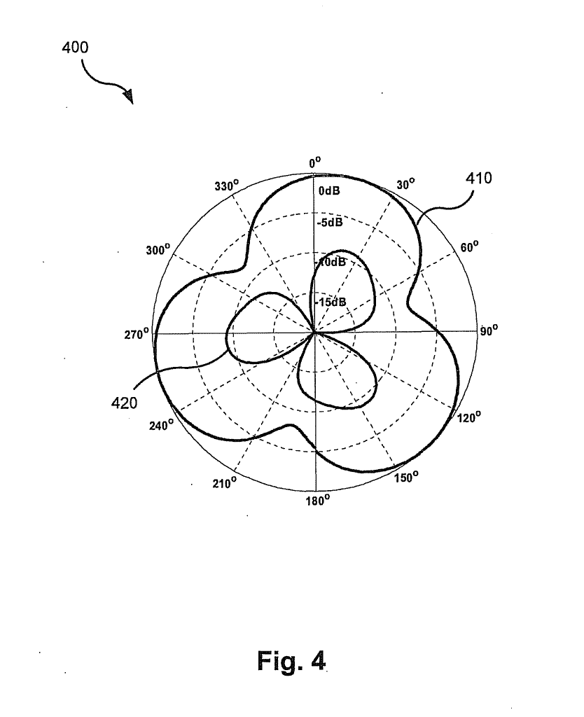

FIG. 4 is a plot 400 of the amplitude of the radiation pattern produced by the antenna 100. The outer trace 410 of the plot 400, which is the amplitude of the co-polar radiation pattern, shows that the pattern of the antenna 100 for co-polar orientation is approximately omni-directional, i.e. of approximately (to within about ±3.5 dB) equal amplitude in all directions. The inner trace 420 of the plot 400 is the amplitude of the cross-polar radiation pattern, which is at least 9 dB less than that of the co-polar pattern in all directions.

The “channel” through which the radiation to or from the antenna 100 passes is in general a highly multipath environment containing multiple scatterers that can rotate the polarisations of incident radiation as well as affect the amplitude and phase. Because the radiation pattern of each column 110-i overlaps with that of at least one other column, and because of the scrambling of polarisation directions in multipath environments, the radiation at any point is a combination of four signals that are subjected to largely independent fading.

The station with which the base station communicates (not shown) is typically a mobile device adapted for wireless communication using two antennas. Examples are a cellular telephone or portable computing device with a wireless adaptor. The mobile device contains a post-processing circuit or module that combines the signals from the antennas, with amplitude scaling and phase shifts, in conventional MIMO fashion.

In other embodiments, the antenna 100 comprises four or six columns 110-i. In the four-column embodiments, the four columns 110-i (i=1, 2, 3, 4) are configured in a square to form the antenna 100. In such embodiments, the two Butler matrices 320 and 360 in the feeding network 300 are four-way Butler matrices, each imparting phase shifts to its two non-zero inputs I₁ and I₂ or I₃ and I₄ that increment by ±90° (or multiples thereof) between the four outputs 330-i or 370-i. In the six-column embodiments, the six columns 110-i (i=1, 2, 3, 4, 5, 6) are configured in a hexagon to form the antenna 100. In such embodiments, the two Butler matrices 320 and 360 in the feeding network 300 are six-way Butler matrices, each imparting phase shifts to its two non-zero inputs I₁ and I₂ or I₃ and I₄ that increment by ±60° (or multiples thereof) between the six outputs 330-i or 370-i. In general, if the number of columns 110-i is N, the phase shifts imparted by each Butler matrix 320 or 360 increment by a multiple of 360° divided by N between its N outputs 330-i or 370-i.

The antenna system comprising the antenna 100 and the feeding network 300 functions as both a transmitter and a receiver without structural alteration.

The arrangements described are applicable to the cellular communication industries.

The foregoing describes only some embodiments of the present invention, and modifications and/or changes can be made thereto without departing from the scope and spirit of the invention, the embodiments being illustrative and not restrictive.

1. An antenna system having an approximately omni-directional radiation pattern, the system comprising:
an antenna comprising a plurality of columns disposed in parallel with equal spacing in a circular configuration, each column comprising:
an elongated ground plane;
an outwards-facing array comprising a plurality of antenna elements mounted on the ground plane in a linear configuration parallel to the longitudinal edges of the ground plane, each antenna, element comprising two feeds configured to produce orthogonally polarised radiation;
a first input connected to the feeds configured for a first polarisation; and
a second input connected to the feeds configured for a second polarisation; and a feeding network, the feeding network comprising:
a first circuit network, and
a second circuit network,
wherein:
the first inputs of the columns are connected to respective outputs of the first circuit network, and the second inputs of the columns are connected to respective outputs of the second circuit network, and
each circuit network is adapted to impart a phase shift to each of two inputs to the circuit network that increments between the outputs of the circuit network by a multiple of 360° divided by the number of columns.

2. An antenna system according to claim 1, wherein the first and second circuit networks are N-way Butler matrices, where N is the number of columns.

3. An antenna system according to claim 1, wherein the phase shifts imparted by either of the two circuit networks to one of the inputs to that circuit network are opposite in sign to the phase shifts imparted by that circuit network to the other of the inputs to that circuit network.

4. An antenna system according to claim 1, wherein each input to the two circuit networks is obtained from a power divider.

5. An antenna system according to claim 1, wherein the distance between adjacent antenna arrays is approximately half a wavelength of the signals provided to the antenna.

6. An antenna system according to claim 1, wherein the number of columns is three.

7. An antenna system according to claim 6, wherein the columns abut each other, so that the ground planes form an equilateral triangle in the transverse direction.

8. An antenna system according to claim 1, wherein the feeds produce linearly polarised radiation in orthogonal directions.

9. An antenna system according to claim 1, wherein the antenna elements in each column are fed through a power divider.

10. An antenna system according to claim 1, wherein the antenna elements in each column are fed through respective phase shifters.

11. A base station for a mobile network comprising the antenna system in accordance with claim 1.

12. A mobile device adapted for wireless communication with a base station in accordance with claim 11.
